(19) United States
(12) Patent Application Publication
(10) Pub. No.: US 2007/0151010 A1
(43) Pub. Date: Jul. 5, 2007

(54) Universal spill and splash resistant pet dish cover

(76) Inventor: Harry La Coste Ellerbe, Atlanta, GA (US)

Correspondence Address: Hill, Kertscher & Wharton, LLP;c/o Hilary A. Wayne, Suite 800, 3350 Riverwood Parkway, Atlanta, GA, 30339, US

(21) Appl. No.: 11/644,700

(22) Filed: Dec. 22, 2006

Related U.S. Application Data
(60) Provisional application No. 60/755,681, filed on Dec. 30, 2005.

(51) Int. Cl. E03D 9/00; F15D 1/00

(52) U.S. Cl. 4/300.3

(57) ABSTRACT

A spill resistant cover which prevents water and food from splashing and spilling from animal water and feeding dishes is disclosed. The one piece cover is elastic in nature to create a watertight seal. The cover is designed to universally fit on any size dish. The cover is also removable by a pull tab to create an easy way of being able to take the cover off and put the cover on various dishes.

### CROSS REFERENCE TO RELATED APPLICATIONS

This application claims the benefit of U.S. Provisional Application No. 60,755,681, filed Dec. 30, 2005.

### STATEMENT REGARDING FEDERALLY SPONSORED RESEARCH OR DEVELOPMENT

Not Applicable

### FIELD OF INVENTION

The present invention relates to the field of pet care accessories and, in particular, to devices for the prevention of water splashing or spilling and food spilling from animal watering and feeding dishes. Specifically, the present invention relates to a universal single piece animal watering dish and/or food dish cover that inhibits the accidental or incidental spilling of water, other liquid, food or other solid pieces while the animal watering or food dish is in motion.

### BACKGROUND OF THE INVENTION

Pets in the United States and other modern countries number in the many millions, and are often regarded as members of the family. Household pets typically live indoors with and often travel with their respective caretakers. Consequently, pets and other confined animals must rely on humans to supply food and fluids.

The general mode of providing animals with foods and fluids is through containers such as a simple dog dish, an old bowl or the like (hereinafter collectively referred to simply as “bowl” or “bowls”). These bowls are typically semi-spherical in shape and, although easily filled with fluid and accessed by an animal, are prone to allowing significant splashing and spillage when the bowl is inadvertently disturbed by sudden movement or contact by an animal or a human caretaker.

With regard to travel, by car or other mode of transportation, animals require fluid and food nourishment to maintain comfort and well-being. This often results in a significant number of inconvenient stops being made to provide the animal with sufficient amounts of fluid or food. As can be appreciated, this extra stopping can substantially increase the required travel time. Furthermore, some animals, such as dogs employed in law enforcement or military operations, may spend many hours per day, several days-per week in a vehicle, and will require a constant supply of fluids and food to remain healthy.

In the typical vehicle, such as a car, truck, boat, or plane, the only suitable location to place such a container is on the floor. As can be appreciated, the motion of the vehicle during operation creates significant jarring, which will inevitably create waves or ripples in the fluid. These waves or ripples in turn will likely cause the fluid to splash or spill from any standard container. The jarring will inevitably cause some of the food pieces to spill from any standard container.

Various attempts to solve this splashing and spilling problem are disclosed in U.S. Pat. Nos. 4,286,546 for “Dog Watering Dish,” U.S. Pat. No. 4,436,056 for “Spill-Resistant Pet Animal Dish,” U.S. Pat. No. 5,791,287 for “Splash-Resistant Pet Water Vessel,” U.S. Pat. No. 5,881,670 for “Splash and Spill-Resistant Container for Animal Use,” and U.S. Pat. No. 6,032,824 for “Spill-Less Wave Bowl”. Each of the devices disclosed in these patents consist of multiple, cumbersome, components and require the caretaker to use the bowl or dish provided therewith. Such a requirement can be very inconvenient, unnecessarily requiring caretaker's to replace functional, and often expensive, bowls and precluding use of the system when the bowl becomes broken or is being washed. Moreover, requiring the use of a particular bowl or dish eliminates the caretaker's ability to choose the appropriate sized bowl or one with a desired shape or appearance. Accordingly, there exists a need for an easy to use, single piece, spill and splash-resistant bowl cover that is suitable for use universally with any size or type of bowl or dish.

### SUMMARY OF THE INVENTION

It is therefore an object of this invention to improve current spill and splash-resistant pet watering and feeding systems by eliminating the requirement of using a specific bowl to make the system functional.

It is another object of this invention to provide a spill and splash-resistant cover equipped to be removably applied to bowls embodying a variety of sizes and shapes.

It is another object of this invention to provide a spill and splash-resistant cover that creates a water tight seal around the bowl.

Still another object of the invention is to provide an uncomplicated, single component anti-spill and splash device that gives rise to economies of scale and greater efficiencies in maintenance and use.

These and other objects are attained in accordance with the present invention wherein there is provided a one piece device suitable for elastic manipulation comprised of a top wall having a central aperture and one or more exterior support structures, a splash and spill diverter wall disposed around the perimeter of the central aperture, and a sidewall surrounding the outer perimeter of the top wall and having traction tread disposed thereon. Ideally, the device will also include one or more pull tabs projecting outwardly from the bottom portion of the sidewall to aid in securing the device to the desired bowl.

### BRIEF DESCRIPTION OF THE DRAWINGS

Further objects of this invention, together with additional features contributing thereto, and advantages accruing therefrom, will be apparent from the following description of the preferred embodiment of the invention when read in conjunction with the accompanying drawings wherein:

FIG. 1 shows the top and side exterior portions of the invention.

FIG. 2 is a bottom view of the invention and shows the interior features described in the corresponding written description.

FIG. 3 is a top view of the invention.

FIG. 4 is a cross-sectional view of the invention.

### DETAILED DESCRIPTION OF THE DRAWINGS

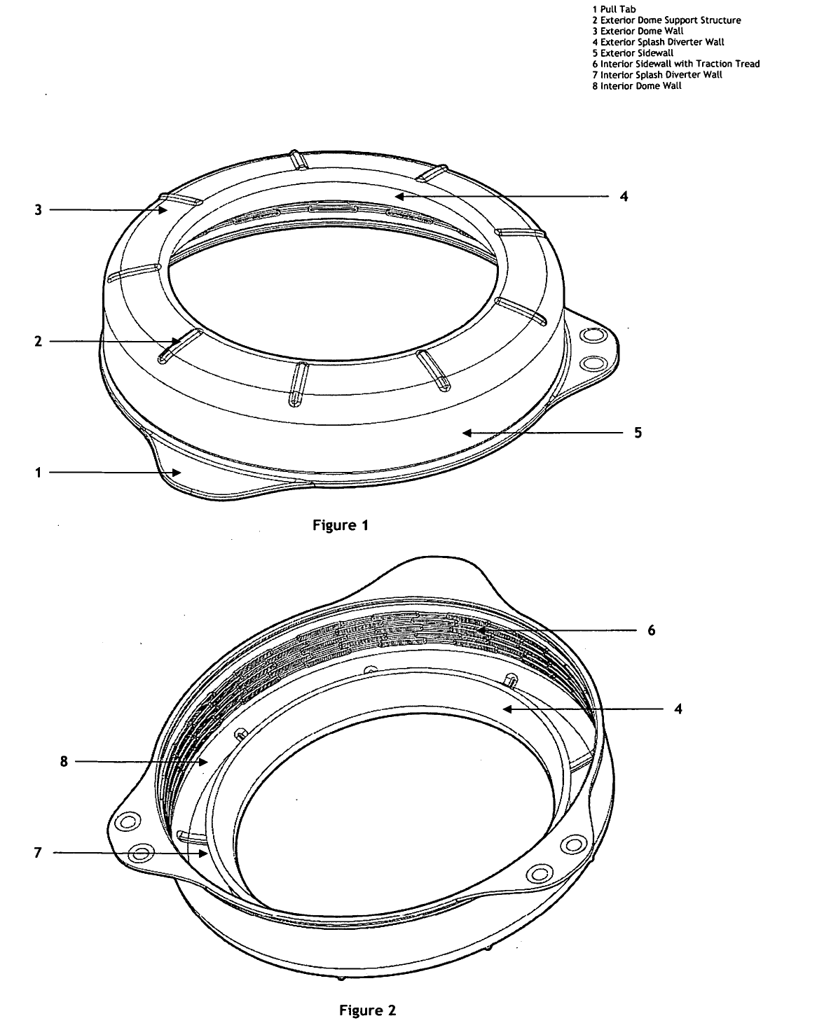

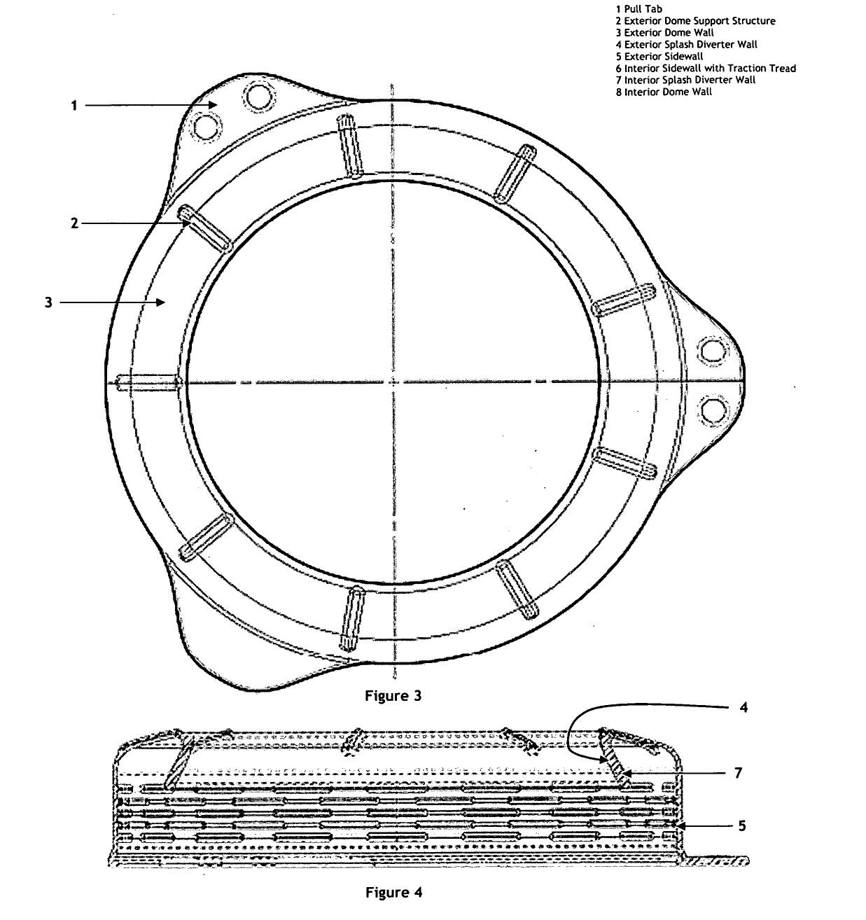

Referring to FIG. 1, it should first be appreciated that the invention is a single, injection molded device, as opposed to the multi-component devices taught by the prior art cited herein. In the preferred embodiment, the invention includes a circular top wall 3 having a central aperture for access to food or fluid. Multiple support structures 2 are positioned at various positions on the top wall 3 to enable the device to maintain proper shape when placed upon a bowl. As can be seen in FIG. 1, the preferred embodiment employs a plurality of radially projecting support structures 2 positioned at approximately evenly spaced intervals upon the entire surface of the top wall 3. However, it will be appreciated that any position, orientation or type of support structure suitable for maintaining the device in a functional shape may also be used without departing from the purpose and spirit of the invention. FIG. 3 is an alternate, top view of the invention showing the preferred position and orientation of the top wall 3, support structures 2 and pull tab(s) 1.

As depicted in FIG. 1, the device includes a sidewall 5 that surrounds the outer perimeter of the top wall 3. Multiple pull-tabs 1 are positioned on the bottom portion of the sidewall 5 and project outwardly for use in pulling the device into position atop the desired bowl. Other means for pulling the device into place (e.g., rings, circular holes in the sidewall) in any number or configuration may also be used.

Referring now to FIG. 2, it can be seen that the interior portion of the sidewall 5 is equipped with traction tread 6. The traction tread 6 creates a watertight seal between the device and the bowl such that splashing fluid will not leak or otherwise escape through the inner margin of the device. Likewise, the traction tread 6 holds the device in position. Thus, when the device is placed upon a bowl, friction between the traction tread 6 and the exterior walls of the particular bowl hold the device in place and creates a watertight seal. Although the shape and orientation of the traction tread 6 upon the interior portion of the sidewall 5 is inconsequential, it is essential that the device include traction tread 6 or other appropriate means to create a watertight seal and prevent the device from slipping or sliding out of position when placed upon contoured or large diameter bowls, such as bowls having sloping exterior sidewalls.

A cross sectional view of the invention, depicted in FIG. 4, shows that a splash and spill diverter wall 4 is disposed around the perimeter of the aperture of the top wall 3. As shown in FIG. 4, splash and spill diverter wall 4 preferably curves inward from the aperture in the top wall 3 such that the wall 4 is angled slightly (e.g., less than 45 degrees) towards the sidewall 5. This shape is intended to minimize splashing and spilling, but, of course, may embody any suitable shape for diverting splashing water and spilling food pieces.

In operation, the device, which should be made from a material suitable for elastic manipulation (i.e., materials that can stretch and or flex without deformation, such as silicone or Neoprene polychloroprene), is stretched across the top of a bowl such that the aperture in the top wall 3 is positioned directly above the bottom surface of the bowl. Preferably, one or more pull tabs 1 are included to aid in pulling the sidewall 5 down around the exterior sidewall of the bowl. That way, the traction tread 6 is in contact with the exterior surface of the bowl sidewall and functions to hold the device in place and create a watertight seal due to friction between the tread 6 and the bowl sidewall.

As suggested by FIG. 4, the splash and spill diverter wall 4 extends down into the bowl from the perimeter of the aperture. For optimal performance, when fluid or food is deposited into the bowl through the aperture in the top wall 3, the fluid or food level should be controlled such that the splash and spill diverter wall 4 does not contact the fluid or food when the bowl is at rest. When the bowl is subsequently bumped by a pet or caretaker or jarred due to the motion of a moving vehicle, fluid waves will travel into the space between the interior of the splash diverter wall 4 and the interior surface of the bowl sidewall. As the waves travel up the interior of the bowl sidewall, fluid is deflected back down into the bowl by the splash and spill diverter wall 4 and/or the top wall 3, thereby minimizing splashing and spilling of fluid. If food pieces are in the bowl, the food pieces are deflected back down into the bowl by the splash and spill diverter wall 4 and/or the top of the wall 3, thereby minimizing spilling of food pieces.

While the invention has been shown, described and illustrated in detail with reference to the preferred embodiment, and possible modifications thereof, it will be understood by those skilled in the art that equivalent changes in form and detail may be made therein without departing from the true spirit and scope of the invention as claimed, except as precluded by the prior art.

The embodiments of the invention for which an exclusive privilege and property right is claimed are defined as follows:

1. A one-piece device for minimizing splashing and spilling of fluid contained within a bowl, the device being suitable for elastic manipulation and comprising:
a top wall having a central aperture and one or more exterior support structures integrated therewith;
a splash diverter wall disposed around the perimeter of the central aperture; and
a sidewall surrounding the outer perimeter of the top wall and having traction tread integrated therewith.

2. The device of claim 1, further including one or more structures associated with the sidewall suitable to facilitate positioning the device upon a bowl such that the traction tread is in contact with the exterior surface of the bowl sidewall.

3. The device of claim 2, wherein the one or more structures are pull tabs.

4. A method of minimizing the splashing or spilling of fluid to be deposited within a bowl comprising the steps of:
positioning a stretchable covering device over the opening of the bowl, the stretchable covering device comprising an aperture, a fluid deflecting structure and one or more structures for pulling the stretchable covering device into position;
pulling the stretchable covering device downward using the one or more structures for pulling the stretchable covering device into position, such that the stretchable covering device is in contact with the entire perimeter of the exterior sidewall of the bowl; and
depositing fluid into the bowl through the aperture such that the fluid level remains below the fluid deflecting structure.

5. The method of claim 4, wherein the one or more structures for pulling the stretchable covering device into position is a pull tab.

6. A device for minimizing splashing and spilling within a bowl, the device being suitable for elastic manipulation and comprising:
a top wall having a central aperture and one or more exterior support structures integrated therewith;
a diverter wall disposed around the perimeter of the central aperture; and
a sidewall surrounding the outer perimeter of the top wall and having traction tread integrated therewith.

7. The device of claim 6, wherein the traction tread is in contact with the exterior surface of the bowl sidewall.

8. The device of claim 7, wherein the traction tread creates a non-movable watertight seal between the device and the bowl.

9. The device of claim 8, including one or more pull tabs.

10. A method of minimizing the splashing or spilling of substances to be deposited within a bowl comprising the steps of:
positioning a stretchable covering device over the opening of the bowl, the stretchable covering device comprising an aperture, a fluid deflecting structure and one or more structures for pulling the stretchable covering device into position;
pulling the stretchable covering device downward using the one or more structures for pulling the stretchable covering device into position, such that the stretchable covering device is in contact with the entire perimeter of the exterior sidewall of the bowl; and
depositing fluid into the bowl through the aperture such that the fluid level remains below the fluid deflecting structure.

11. The method of claim 10, wherein a pull tab is used to pull the stretchable covering device into position.

12. A one-piece device comprising:
an elastic top wall having a central aperture and one or more exterior support structures integrated therewith;
an elastic diverter wall disposed around the perimeter of the central aperture; and
an elastic sidewall surrounding the outer perimeter of the top wall and having traction tread integrated therewith.

13. The device of claim 12, wherein the traction tread is in contact with the exterior surface of the bowl sidewall.

14. The device of claim 13, wherein the traction tread creates a watertight seal between the device and the bowl.

15. The device of claim 14, including one or more pull tabs.
